(19) United States
(12) Patent Application Publication
(10) Pub. No.: US 2012/0098545 A1
(43) Pub. Date: Apr. 26, 2012

(54) Plasma Diagnostic Apparatus And Method For Controlling The Same

(75) Inventors: Gil Su Son, Yongin-Si (KR); Su Hong Kim, Yongin-Si (KR); Myoung Woon Kim, Suwon-Si (KR); Hyung Chul Cho, Suwon-Si (KR); Seong Chul Choi, Suwon-Si (KR)

(73) Assignee: SAMSUNG ELECTRONICS CO., LTD., Suwon-si (KR)

(21) Appl. No.: 13/271,779

(22) Filed: Oct. 12, 2011

(30) Foreign Application Priority Data
Oct. 21, 2010 (KR) 10-2010-0102874

(51) Int. Cl. G01N 27/62

(52) U.S. Cl. 324/464

(57) ABSTRACT

An example embodiment relates to a plasma diagnostic apparatus that exists outside of a plasma generation chamber. The plasma diagnostic apparatus is configured to recognize and/or diagnose a state of plasma using a signal flowing from a floated electrode of a plasma generation apparatus to determine a diagnostic factor of the plasma.

### CROSS-REFERENCE TO RELATED APPLICATION

This application claims priority under 35 U.S.C. §119 to the benefit of Korean Patent Application No. 2010-0102874, filed on Oct. 21, 2010 in the Korean Intellectual Property Office, the contents of which is incorporated herein in its entirety by reference.

### BACKGROUND

1. Field

Example embodiments relate to a plasma diagnostic apparatus for diagnosing a plasma state by analyzing a signal received from plasma, and a method for controlling the same.

2. Description of the Related Art

An apparatus that generates plasma through high-frequency power may be used for forming and/or removing a thin film during the fabrication process of a semiconductor device.

Plasma apparatuses have several features. First a plasma apparatus can deposit a thin film using a fabrication process at low temperature, a temperature at which impurities contained in an impurity region formed in a wafer are not diffused readily. Second plasma apparatuses may have good thin-film deposition uniformity on a large-diameter wafer. Third, plasma apparatuses may have good etch uniformity on a wafer during the etching of the thin film. For the aforementioned reasons, plasma apparatuses may be applied to a variety of technical fields.

For plasma apparatuses, the uniformity of ion energy distributed in a process space affects the process. For plasma etching apparatuses, the etch process is not only a chemical reaction caused by radicals contained in plasma, but the process may also be a physical reaction caused by the high-energy ion assisted etching effect. Therefore, if the ion energy distribution is non-uniform, a pattern may be damaged if local areas are etched excessively and some parts are not etched at all. As a result, the technology for measuring/improving energy distribution of ion generated from the plasma apparatus is being researched.

A Langmuir probe can analyze plasma characteristics such as ion distribution and electron distribution.

In the Langmuir probe, a probe formed of metal is inserted into a chamber. A voltage is applied to the probe while current flowing in the probe is measured in order to produce a current-voltage characteristic curve. From the current-voltage curve, electron saturation current, ion saturation current, an electron temperature, plasma potential, etc. can be obtained.

However, inserting the probe into the chamber to measure plasma according to the related art may cause problems (e.g., particle occurrence, fabrication variation, etc.) encountered in mass production.

Therefore, it is desirable to develop a method for recognizing/diagnosing plasma without changing the inner part of the chamber.

### SUMMARY

Example embodiments relate to a plasma diagnostic apparatus for analyzing a plasma state without inserting a probe into the chamber that generates the plasma, and a method for controlling the same.

Additional aspects of example embodiments will be set forth in part in the description which follows and, in part, will be obvious from the description, or may be learned by practice of the example embodiments.

In accordance with one aspect of the example embodiments, there is provided a plasma diagnostic apparatus, the plasma generation apparatus including upper electrode facing a lower electrode, and a radio frequency (RF) power generator coupled to the lower electrode, the upper electrode configured to receive a voltage from a direct current (DC) generator, the apparatus including a current sensing unit configured to detect a current signal from a signal flowing from the upper electrode to the DC generator, and a controller configured to receive the current signal from the current sensing unit and to calculate a diagnostic factor that indicates a state of a plasma generated in the plasma generation apparatus, the controller configured to determine whether the plasma is abnormal or normal on the basis of the calculated diagnostic factor.

The controller may be configured to calculate the diagnostic factor based on the current signal and a frequency signal obtained by a conversion of the current signal.

The controller may be configured to compare the current signal and the frequency signal with a reference current signal and a frequency signal respectively of a reference waveform, and the controller may be configured to calculate the diagnostic factor based on a difference between current signal and the reference current signal and a difference between a center of the frequency signal and a center of the reference frequency signal for respective harmonic waves.

The controller may be configured determine that the plasma is normal when the calculated diagnostic factor is in a normal range, and the controller may be configured to determine that the plasma is abnormal when the calculated diagnostic factor is out of the normal range.

The plasma diagnostic apparatus may further include a display connected to the controller, wherein the controller is configured to send a message that instructs the display to display a message that indicates an abnormal state of the plasma, if the controller determines an abnormal state of the plasma.

The plasma diagnostic apparatus may further include a voltage sensing unit to detect a voltage configured to detect a voltage from the upper electrode, wherein the controller is configured to receive the voltage detected by the voltage sensing unit and to calculate the diagnostic factor based on the current signal, a frequency signal obtained by conversion of the current signal, and a voltage signal detected by the voltage sensing unit.

The controller may be configured to determine that the plasma is normal when the calculated diagnostic factor is in a normal range, and the controller may be configured to determine that the plasma is abnormal when the calculated diagnostic factor is out of the normal range.

In accordance with another aspect of the example embodiments, there is provided a method for controlling a plasma diagnostic apparatus that is coupled to a plasma generation apparatus, the plasma generation apparatus including an upper electrode facing a lower electrode, and a radio frequency (RF) power generator coupled to the lower electrode, the upper electrode configured to receive a voltage, the method including detecting a current signal flowing from the upper electrode to the DC generator, calculating a diagnostic factor indicating a state of plasma generated in the chamber using the detected current signal, and determining whether the plasma is abnormal or normal on the basis of the calculated diagnostic factor.

The calculating the diagnostic factor may include calculating the diagnostic factor using the detected current signal and a frequency signal obtained by conversion of the current signal.

The calculating the diagnostic factor may include comparing the current signal and the frequency signal obtained by conversion of the current signal with a current signal and a frequency signal respectively of a reference waveform, and calculating the diagnostic factor based on a difference between the current signals and a difference in center frequency between respective harmonic waves.

The determining whether the plasma is abnormal or normal may include determining that the plasma is normal when the calculated diagnostic factor is in a normal range, and determining that the plasma is abnormal when the calculated diagnostic factor is out of the normal range.

The method may further include, if the abnormal state of the plasma is determined, displaying information indicating the abnormal plasma on a display.

The method may further include detecting a voltage from the upper electrode, and the calculating of the diagnostic factor includes calculating the diagnostic factor using the current signal, a frequency signal obtained by conversion of the current signal, and a voltage signal detected by the voltage sensing unit.

The method may further include determining that the plasma is normal when the calculated diagnostic factor is in a normal range, and determining that the plasma is abnormal when the calculated diagnostic factor is out of the normal range.

### BRIEF DESCRIPTION OF THE DRAWINGS

These and/or other aspects of the example embodiments will become apparent and more readily appreciated from the following description of non-limiting example embodiments, as illustrated in the accompanying drawings in which like reference characters refer to the same parts throughout the different views. The drawings are not necessarily to scale, emphasis instead being placed upon illustrating the principles of the example embodiments. In the drawings:

FIG. 1 is a configuration diagram illustrating a plasma diagnostic apparatus according to an example embodiment.

FIG. 2 is a control block diagram illustrating a plasma diagnostic apparatus according to an example embodiment.

FIG. 3 is a control block diagram illustrating a plasma diagnostic apparatus according to another example embodiment.

FIG. 4 is a flowchart illustrating a plasma diagnostic apparatus according to an example embodiment.

FIG. 5 is a graph illustrating the relationship between a waveform actually measured by a plasma diagnostic apparatus and a reference waveform according to an example embodiment.

### DETAILED DESCRIPTION

Example embodiments will now be described more fully with reference to the accompanying drawings, in which some example embodiments are shown. Example embodiments, may, however, be embodied in many different forms and should not be construed as being limited to the embodiments set forth herein; rather, these embodiments are provided so that this disclosure will be thorough and complete, and will fully convey concepts of example embodiments to those of ordinary skill in the art. In the drawings, the thicknesses of layers and regions are exaggerated for clarity. Like reference numerals in the drawings denote like elements, and thus their description will be omitted. It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Plasma generation apparatuses can be largely classified as a Capacitive Coupled Plasma (CCP) plasma generation apparatus and/or an Inductive Coupled Plasma (ICP) plasma generation apparatus, based on the plasma forming method. The CCP plasma generation apparatus can generate high-energy ions using a high electric field

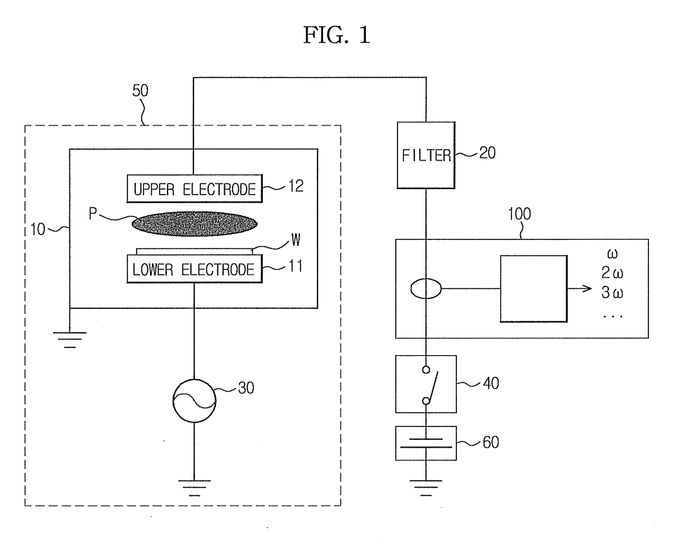

FIG. 1 is a configuration diagram illustrating a plasma diagnostic apparatus according to an example embodiment.

Referring to FIG. 1, the plasma diagnostic apparatus 100 is coupled to a Capacitive Coupled Plasma (CCP) plasma generation apparatus 50. The plasma diagnostic apparatus 100 analyzes a signal flowing in the floated electrode of the plasma generation apparatus 50, and analyzes/diagnoses a plasma state.

Plasma generation apparatuses can be largely classified as a Capacitive Coupled Plasma (CCP) plasma generation apparatus and/or an Inductive Coupled Plasma (ICP) plasma generation apparatus, based on the plasma forming method.

The CCP plasma generation apparatus 50 includes a lower electrode 11 and an upper electrode 12 in the chamber 10. In this case, the lower electrode 11 and the upper electrode 12 face each other.

The lower electrode of some CCP plasma generation apparatuses 50 is coupled to a Radio Frequency (RF) generator 30 applying high-frequency power, and the upper electrode 12 receives a negative (−) voltage from the grounded DC generator 60 so that it floats.

In the above-mentioned CCP plasma generation apparatus 50, the upper electrode 12 installed in the chamber 10 may be configured in the form of a flat panel formed of a conductive material. Fabrication gases may be supplied from an external source through the upper electrode 12 so the upper electrode 12 diffuses at least one fabrication gas to uniformly provide reaction gases to the inside of the chamber 10. The upper electrode 12 may be formed of materials and structures suitable for individual processes of the semiconductor fabrication devices.

In addition, the lower electrode 11 installed in the chamber 10 may be an electrostatic chuck (ESC) and may also be used as an electrode, but example embodiments are not limited thereto.

The RF generator 30 applies RF power to the lower electrode 11 in order to generate a plasma in the chamber 10.

In the CCP plasma generation apparatus 50, a vacuum pump (not shown) may withdraw gas from the process chamber 10 in order to create a vacuum state in the chamber 10. Reaction gases for generating plasma may be supplied through a gas nozzle (not shown) in order to inject gas into the plasma generation apparatus 50. The reaction gases may be diffused through the upper electrode 12, but example embodiments are not limited thereto. The pressure of the chamber 10 may be maintained at a desired or predetermined pressure by supplying reaction gases to increase pressure and by removing gases to reduce pressure.

In order to generate plasma P, RF power may be applied to the lower electrode 11 contained in the chamber 10 from the RF generator 30.

If the RF power is applied to the plasma generation apparatus 50, induced electric field (not shown) occurs in the chamber 10, and the induced electric field accelerates reaction gas particles contained in the chamber 10, such that the reaction gas is excited and ionized and thus plasma is generated. By means of the plasma and reaction gases, a wafer (W) loaded on the lower electrode 11 and may be etched.

Numerous frequency signals (for example, fundamental waves, primary harmonic waves, secondary harmonic waves) are emitted from the inside of the chamber 10 to the outside of the chamber 10, and some frequency signals flow to a ground terminal along a lateral surface of the chamber part.

Meanwhile, some frequency signals flow to the DC generator 60 through the upper electrode 12. That is, signals flow in the upper electrode 12 by the plasma P generated in the chamber 10. Among the flowing signals, some signals pass through the filter 20, and flow to the ground terminal after passing through the switching unit 40 and the DC generator 60.

The signals flowing in the DC generator 60 through the upper electrode 12 by plasma P may include even a minute variation of such plasma.

The plasma diagnostic apparatus 100 according to an example embodiment analyzes and diagnoses at least one signal flowing from the upper electrode 12 to the DC generator 60 by the plasma P generated in the chamber 10 of the plasma generation apparatus. The plasma diagnostic apparatus 100 can monitor even a minute variation of plasma.

For example, the filter 20 may be a Low Pass Filter (LPF). The upper electrode 12 configured to receive the DC voltage may float such that uniform plasma density and a large-sized plasma P can be provided from the viewpoint of RF frequency.

The LPF 20 is positioned between the upper electrode 12 and the DC generator 60. By means of the LPF 20, a current including a frequency of about several tens of KHz from among a surface wave encountered between hardware of the upper electrode 12 and the surface contacting the plasma passes through the LPF 20 and then flows into the DC generator 60.

The current includes all the fine variations of plasma in the same manner as in a measurement probe directly inserted into the chamber 10, such that the fine variations of plasma can be monitored using the above-mentioned current.

If the switching unit 40 may enable the plasma diagnostic apparatus 100 to measure only a voltage flowing from the upper electrode 12 to the DC generator 60, or may enable the plasma diagnostic apparatus 100 to measure both the voltage and the current.

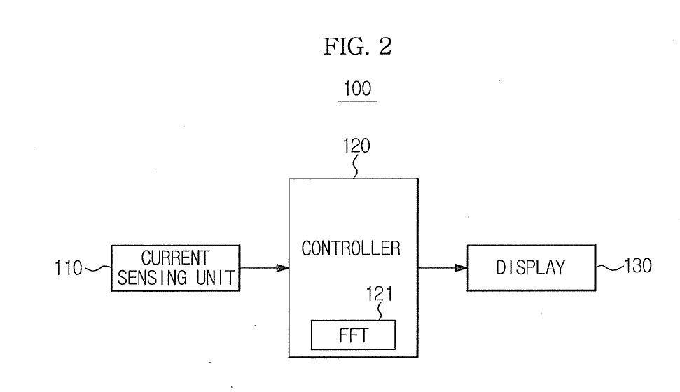

That is, if the switching unit 40 is turned off, the plasma diagnostic apparatus 100 can measure only the voltage. If the switching unit 40 is turned on, the plasma diagnostic apparatus 100 can measure both the voltage and the current. Although the switching unit 40 can be controlled by a microprocessor (MP) controlling the plasma generation apparatus 100, the switching unit 40 can also be controlled by the controller (120, see FIG. 2) of the plasma diagnostic apparatus 100.

FIG. 2 is a control block diagram illustrating a plasma diagnostic apparatus 100 according to an example embodiment.

Referring to FIG. 2, the plasma diagnostic apparatus 100 according to an example embodiment includes a current sensing unit 110, a controller 120 and a display 130.

The current sensing unit 110 detects a current from a specific signal that flows from the upper electrode 12 to the DC generator 60 through the filter 20. For example, the current sensing unit 110 may be a current transformer (CT). The CT sensor allows a signal line, that flows from the upper electrode 12 to the DC generator 60 through the filter 20, to pass through a hole formed by coils wound on a core, such that the CT sensor measures a voltage induced on the secondary coil according to the turn ratio of coils by the current flowing in the signal line, thereby predicting a primary current.

The controller 120 converts the flow of a current signal into the flow of a frequency signal using a Fast Fourier Transform (FFT) 121. The flow of the frequency signal includes a fundamental frequency (f1=w), a secondary harmonic wave (f2w), and a third harmonic wave (f3w).

The controller 120 can correctly divide a target signal into several segments according to individual frequency components through the FFT 121.

The controller 120 calculates a diagnostic factor using a desired or predetermined equation capable of determining whether the plasma generated in the chamber 10 is normal or abnormal on the basis of both a current signal detected by the current sensing unit 110 and a frequency signal obtained by conversion of the current signal through the FFT 121, and determines whether the calculated diagnostic factor is in the normal range. If the calculated diagnostic factor is in the normal range, then the controller 120 determines that the plasma generated in the chamber 10 is normal. If the calculated diagnostic factor is out of the normal range, the controller 120 determines that the plasma generated in the chamber 10 is abnormal.

In the case where the diagnostic factor calculated from the current signal and the frequency signal is out of the normal range and the plasma generated in the chamber 10 is abnormal, the controller 120 displays the abnormal state of the plasma on the display 130.

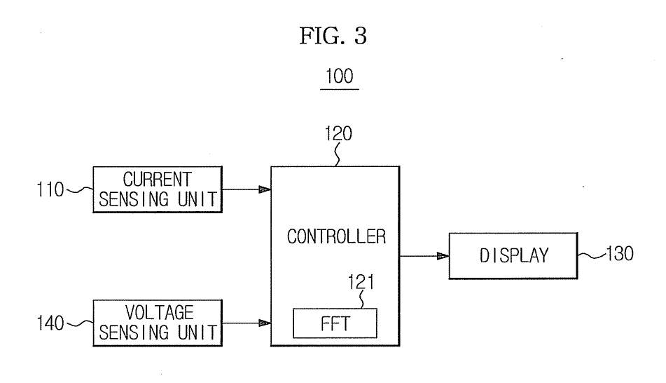

FIG. 3 is a control block diagram illustrating a plasma diagnostic apparatus according to an example embodiment.

Referring to FIG. 3, the plasma diagnostic apparatus according to an example embodiment includes a current sensing unit 110, a voltage sensing unit 140, a controller 120, and a display 130.

The current sensing unit 110 detects a current from a specific signal that flows from the upper electrode 12 to the DC generator 60 through the filter 20. For example, the current sensing unit 110 may be a current transformer (CT). The CT sensor allows a signal line, that flows from the upper electrode 12 to the DC generator 60 through the filter 20, to pass through a hole formed by coils wound on a core, such that the CT sensor measures a voltage induced on the secondary coil according to the turn ratio of coils by the current flowing in the signal line, thereby predicting a primary current.

The voltage sensing unit 140 detects a voltage from a specific signal that flows from the upper electrode 12 to the DC generator 60 through the filter 20. The voltage sensing unit 140 includes a voltage sensor.

The controller 120 converts the flow of a current signal into the flow of a frequency signal using a Fast Fourier Transform (FFT) 121. The flow of the frequency signal includes a fundamental frequency (f1=w), a secondary harmonic wave (f2w), and a third harmonic wave (f3w). The controller 120 can correctly divide a target signal into several segments according to individual frequency components through the FFT 121.

The controller 120 calculates a diagnostic factor using a desired or predetermined equation capable of determining whether the plasma generated in the chamber 10 is normal or abnormal on the basis of both a current signal detected by the current sensing unit 110 and a frequency signal obtained by conversion of the current signal through the FFT 121. The controller 120 determines whether the calculated diagnostic factor is in the normal range. If the calculated diagnostic factor is in the normal range, the controller 120 determines that the plasma generated in the chamber 10 is normal. If the calculated diagnostic factor is out of the normal range, the controller 120 determines that the plasma generated in the chamber 10 is abnormal.

In the case where the diagnostic factor calculated from the current signal, the frequency signal and the voltage signal is out of the normal range and the plasma generated in the chamber 10 is abnormal, the controller 120 displays the abnormal state of the plasma on the display 130.

In brief, although the plasma diagnostic apparatus according to example embodiments can determine whether the plasma generated in the chamber 10 is normal or abnormal using a current signal and a frequency signal as shown in FIG. 2, the plasma diagnostic apparatus can determine whether the plasma is normal or abnormal by detecting even a voltage signal as shown in FIG. 3. It is difficult to determine whether some plasma is in an abnormal state using only the current signal and the frequency signal, such that the abnormal state of the plasma can be more accurately determined using the voltage signal more and more.

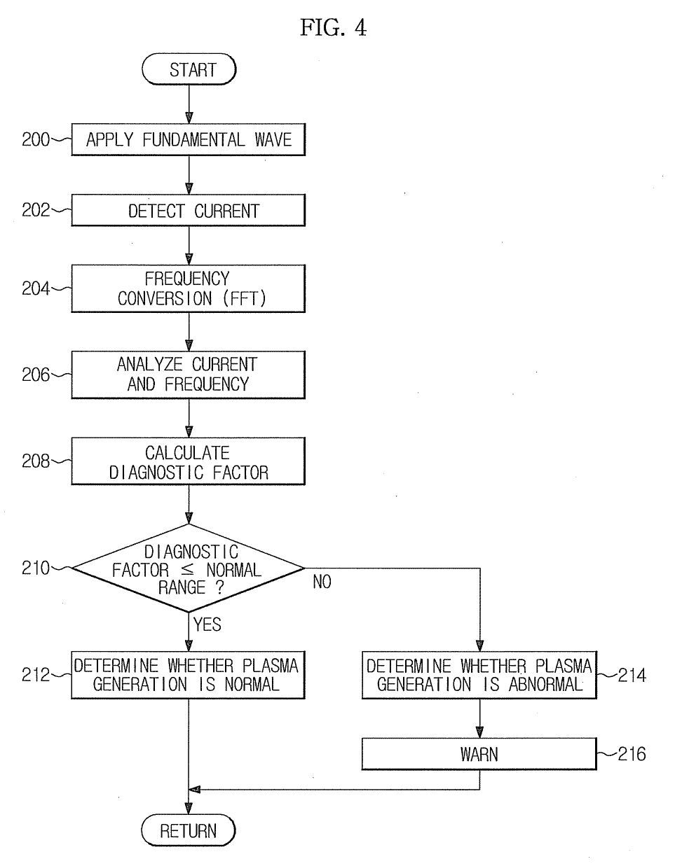

FIG. 4 is a flowchart illustrating a plasma diagnostic apparatus according to an example embodiment.

Referring to FIG. 4, the RF generator 30 for use in the plasma generation apparatus applies RF power serving as a fundamental wave to the lower electrode 11 of the chamber 10 at operation 200, and goes to the next operation 202.

If the plasma generation apparatus applies the RF power to the lower electrode 11 contained in the chamber 10 through the RF generator 30 so as to generate plasma in the chamber 10 at operation 200, the induced electric field 55 occurs in the chamber 10. The induced electric field accelerates reaction gas particles contained in the chamber 10, such that the reaction gas is excited and ionized, resulting in creation of plasma.

In this case, the plasma generated in the chamber 10 produces numerous frequency signals (e.g., a fundamental wave, a primary harmonic wave, a secondary harmonic wave, etc.) emitted from the inside of the chamber to the outside of the chamber, and some frequency signals flow to the DC generator 40 through the upper electrode 12.

The signal flowing to the DC generator 60 through the upper electrode 12 by the plasma includes even fine variations of plasma.

The controller 120 for use in the plasma diagnostic apparatus 100 according to an example embodiment detects the current signal through the current sensing unit 110 at operation 202.

The plasma diagnostic apparatus 100, by the plasma, detects a current signal from a specific signal that flows to the DC generator 60 through the upper electrode 12, and converts the current signal into a frequency signal through the FFT 121 at operation 204.

After converting the current signal into the frequency signal, the controller 120 analyzes current information and frequency information from the current signal and the frequency signal at operation 206.

The controller 120 calculates a diagnostic factor using a desired or predetermined equation that is capable of determining whether the plasma generated in the chamber 10 is normal on the basis of the analyzed current information and the analyzed frequency information at operation 208.

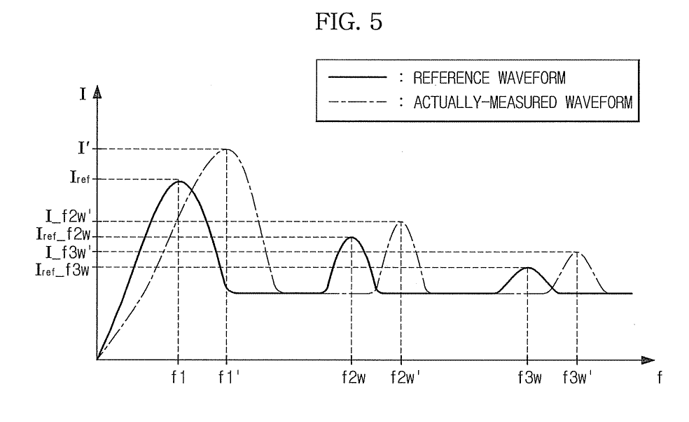

FIG. 5 is a graph illustrating the relationship between a waveform actually measured by a plasma diagnostic apparatus and a reference waveform according to an example embodiment.

Referring to FIG. 5, a solid-lined waveform indicates a reference waveform, and a dotted-lined waveform indicates a waveform actually-measured according to a current signal and a frequency signal.

The center frequency and the current of the primary harmonic wave of a solid-lined reference waveform are denoted by f1 and Iref, respectively. The center frequency and the current of the solid-lined secondary harmonic wave are denoted by f2w and Iref_f2w, respectively. The center frequency and the current of the solid-lined third harmonic wave are denoted by f3w and Iref_f3w, respectively.

Meanwhile, the current frequency and the current of the primary harmonic wave of the dotted-lined waveform are denoted by f1′ and I′, respectively. The current frequency and the current of the dotted-lined secondary harmonic wave are denoted by f2w′ and I_f2w′, respectively. The current frequency and the current of the dotted-lined third harmonic wave are denoted by f3w′ and I_f3w′, respectively.

The controller 120 calculates a difference (f1′−f1) between the center frequency f1 of the primary harmonic wave of the reference waveform and the center frequency f1′ of the primary harmonic wave of the actually-measured waveform, calculates a difference (f2w′−f2w) between the center frequency f2w of the secondary harmonic wave of the reference waveform and the center frequency f2w′ of the secondary harmonic wave of the actually-measured waveform, and calculates a difference (f3w′−f3w) between the center frequency f3w of the third harmonic wave of the reference waveform and the center frequency f3w′ of the third harmonic wave of the actually-measured waveform.

In addition, the controller 120 calculates a difference (I′−Iref) between the current Iref of the primary harmonic wave of the reference waveform and the current I′ of the primary harmonic wave of the actually-measured waveform, calculates a difference (I_f2w′−I_f2w) between the current Iref_f2w of the secondary harmonic wave of the reference waveform and the current I_f2w of the secondary harmonic wave of the actually-measured waveform, and calculates a difference (I_f3w′−I_f3w) between the current Iref_f3w of the third harmonic wave of the reference waveform and the current I_f3w′ of the third harmonic wave of the actually-measured waveform.

The difference in center frequency among the primary harmonic wave, the secondary harmonic wave, and the third harmonic wave, and the difference in current among the primary harmonic wave, the secondary harmonic wave, and the third harmonic wave are input to the desired or predetermined equation, thereby calculating a diagnostic factor.

After calculating the diagnostic factor as shown in FIG. 4, the controller 120 determines whether the calculated diagnostic factor is in the normal range at operation 210.

If the calculated diagnostic factor is in the normal range at operation 210, the controller 120 determines that the plasma generated in the chamber 10 is normal at operation 212.

Meanwhile, if the calculated diagnostic factor is out of the normal range at operation 210, the controller 120 determines that the plasma generated in the chamber 10 is abnormal at operation 214.

If the plasma generated in the chamber is abnormal, the controller 120 displays a warning message indicating the abnormal state of the plasma generated in the chamber 10 on the display 130.

As is apparent from the above description, the plasma diagnostic apparatus and the method for controlling the same according to example embodiments can recognize and diagnose a plasma state using a signal flowing in an electrode floated in the chamber that generates plasma, such that the apparatus and method can measure even a minute variation of plasma without changing not only the inner structure of the chamber but also the inner state of the chamber. As a result, the above-mentioned plasma diagnostic apparatus and method can obtain the substantially same effect as if the measurement probe has been inserted into the chamber.

Although a few example embodiments have been shown and described, it would be appreciated by those skilled in the art that changes may be made in these embodiments without departing from the principles and spirit of the claims.

What is claimed is:

1. A plasma diagnostic apparatus coupled to a plasma generation apparatus,
the plasma generation apparatus including an upper electrode facing a lower electrode, and a radio frequency (RF) power generator coupled to the lower electrode,
the upper electrode configured to receive a voltage from a direct current (DC) generator, the apparatus comprising:
a current sensing unit configured to detect a current signal from a signal flowing from the upper electrode to the DC generator; and
a controller configured to receive the current signal from the current sensing unit and to calculate a diagnostic factor that indicates a state of a plasma generated in the plasma generation apparatus, the controller configured to determine whether the plasma is abnormal or normal on the basis of the calculated diagnostic factor.

2. The plasma diagnostic apparatus according to claim 1, wherein the controller is configured to calculate the diagnostic factor based on the current signal and a frequency signal obtained by a conversion of the current signal.

3. The plasma diagnostic apparatus according to claim 2, wherein the controller is configured to compare the current signal and the frequency signal with a reference current signal and a reference frequency signal respectively of a reference waveform, and the controller is configured to calculate the diagnostic factor based on a difference between the current signal and the reference current signal and a difference between a center of the frequency signal and a center of the reference frequency signal for respective harmonic waves.

4. The plasma diagnostic apparatus according to claim 3, wherein the controller is configured to determine the plasma is normal when the calculated diagnostic factor is in a normal range, and the controller is configured to determine the plasma is abnormal when the calculated diagnostic factor is out of the normal range.

5. The plasma diagnostic apparatus according to claim 4, further comprising:
a display connected to the controller,
wherein the controller is configured to send a message that instructs the display to display a message that indicates an abnormal state of the plasma, if the controller determines an abnormal state of the plasma.

6. The plasma diagnostic apparatus according to claim 1, further comprising:
a voltage sensing unit configured unit to detect a voltage from the upper electrode,
wherein the controller is configured to receive the voltage detected by the voltage sensing unit and to calculate the diagnostic factor based on the current signal, a frequency signal obtained by conversion of the current signal, and the voltage detected by the voltage sensing unit.

7. The plasma diagnostic apparatus according to claim 6, wherein the controller is configured to determine the plasma is normal when the calculated diagnostic factor is in a normal range, and the controller is configured to determine that the plasma is abnormal when the calculated diagnostic factor is out of the normal range.

8. A method for controlling a plasma diagnostic apparatus coupled to a plasma generation apparatus,
the plasma generation apparatus including an upper electrode facing a lower electrode, and a radio frequency (RF) power generator coupled to the lower electrode,
the upper electrode configured to receive a voltage from a direct current (DC) generator, the method comprising:
detecting a current signal flowing from the upper electrode to the DC generator;
calculating a diagnostic factor indicating a state of plasma generated in the plasma generation apparatus using the detected current signal; and
determining whether the plasma is abnormal or normal on the basis of the calculated diagnostic factor.

9. The method according to claim 8, wherein the calculating the diagnostic factor includes calculating the diagnostic factor using the detected current signal and a frequency signal obtained by conversion of the current signal.

10. The method according to claim 9, wherein the calculating the diagnostic factor includes:
comparing the current signal and the frequency signal obtained by conversion of the current signal with a current signal and a frequency signal respectively of a reference waveform; and
calculating the diagnostic factor based on a difference between the current signals and a difference in center frequency between respective harmonic waves.

11. The method according to claim 10, wherein the determining whether the plasma is abnormal or normal includes:
determining that the plasma is normal when the calculated diagnostic factor is in a normal range; and
determining that the plasma is abnormal when the calculated diagnostic factor is out of the normal range.

12. The method according to claim 11, further comprising:
if the abnormal state of the plasma is determined, displaying information indicating the abnormal plasma on a display.

13. The method according to claim 8, further comprising:
detecting a voltage from the upper electrode, and
the calculating of the diagnostic factor includes calculating the diagnostic factor using the current signal, a frequency signal obtained by conversion of the current signal, and the detected voltage.

14. The method according to claim 13, further comprising:
determining that the plasma is normal when the calculated diagnostic factor is in a normal range, and determining that the plasma is abnormal when the calculated diagnostic factor is out of the normal range.
